(19) United States
(12) Patent Application Publication
(10) Pub. No.: US 2015/0311591 A1
(43) Pub. Date: Oct. 29, 2015

(54) PRINTED ANTENNA HAVING NON-UNIFORM LAYERS

(71) Applicant: VAYYAR IMAGING LTD, Yehud (IL)

(72) Inventor: Harel GOLOMBEK, Netanya (IL)

(21) Appl. No.: 14/696,813

(22) Filed: Apr. 27, 2015

Related U.S. Application Data
(60) Provisional application No. 61/984,820, filed on Apr. 27, 2014.

(51) Int. Cl. H01Q 9/04; H01Q 21/06; H01Q 19/10

(52) U.S. Cl. CPC H01Q 9/0407; H01Q 19/10; H01Q 21/06

(57) ABSTRACT

An antenna has a plurality of dielectric layers and a plurality of conducting layers. At least one of the dielectric layers comprises one or more regions with differing dielectric properties. A plurality of such antennas may be arranged in an antenna array. The array includes a radiating component etched in the array top first layer, a reflector embedded in a second layer below the top layer, a feeding network located in a third layer below the reflector, and a ground plane bottom layer configured to shield the feeding network in the bottom layer. At least one of the layers of the array is a non-uniform dielectric layer of a material having a substantially different electrical property compared to the array dielectric and conducting layers.

### FIELD OF THE INVENTION

The present invention relates to printed antennas for radiating and receiving electromagnetic waves and, more particularly to a low profile, printed circuit board (PCB) antenna.

### BACKGROUND INFORMATION

Printed antennas such as PCB based antennas as known in the art may include a plurality of layers having various shapes, size and thickness, where each layer is interconnected with conductive vias, to further provide electrical connections for complex electronic circuitry. Conventional PCBs include a rigid substrate to provide support for mounting electronic components in communications and sensing devices. In addition, conductive materials are plated over such substrates and etched to provide electrically conductive traces for interconnecting these components.

For many devices, antennas are typically formed on the same PCBs, which also carry transmitting and receiving radio frequency (RF) circuitry. A common technique employed to form antennas on PCBs is to simply etch conducting surfaces composing the antenna, having an antenna feeder trace coupled to desired components on the PCB. Since space is limited in the ever-decreasing size of today's devices, such antenna traces are typically formed near one or more ground planes formed on the same PCB. In such arrangements, a portion of the PCB substrate, typically the area of a PCB having the highest density of electromagnetic energy, remains in between the antenna and the ground plane, impacting antenna efficiency and bandwidth.

More specifically, as radio signals travel along an antenna trace, a portion of the signals are typically “lost” through energy loss or dissipation in the medium around the antenna trace, especially the medium between the antenna trace and the ground plane. The portion of total initial RF signals radiated into the surrounding space determines the antenna transmission efficiency (measured in dB) of the antenna. The same principle applies for antenna reception. Ideally, a 100% efficiency (0 dB loss) would be achieved if all of the RF signals traveling through the antenna were radiated into the surrounding space. However, as may be expected, the material from which a PCB is constructed has a large impact on the percentage of RF signals that are dissipated into PCB material surrounding the antenna structure.

According to one embodiment of the prior art, a printed antenna may include a single conducting layer and a single dielectric layer while a more complicated printed antenna design may include a multi-layer configuration, including a plurality of conducting interconnections (e.g. via holes) between the conducting layers.

A multi-layer printed antenna may be formed on a dielectric substrate (non-conducting) and conducting substrate, where each adjacent pair of conducting layers are separated by at least one dielectric layer. Commonly used materials used for a multi-layer PCB antenna include for example glass-epoxy or Teflon (PTFE) (i.e. the dielectric materials) and copper (i.e. the conducting material).

FIG. 1 illustrates a cross section view of a multi-layer PCB 100 embodiment according to the prior art. The PCB 100 includes four conducting layers 112, 114, 116, 118 and three dielectric layers 113, 115 and 117. A typical antenna design embedded in the multi-layer PCB 100 include the following elements: a) a radiating element etched in the top conducting copper layer (112) b) a reflector (e.g. ground plane) embedded in the conducting layer below it (114) c) a feeding network in the layer below the reflector (116) and d) an additional ground plane to shield the feeding network in the bottom conducting layer (118).

Printed circuit antennas are often used in antenna arrays, when the printed circuit board technology is used to produce a group of antennas using a common substrate.

There are multiple performance criteria applicable to antennas: gain, bandwidth, matching, impulse response duration are an example of some. In antenna arrays, coupling between antennas in an array is an important factor.

### SUMMARY OF INVENTION

It is an objective of the present invention to provide printed circuit antennas with low ringing time and reduced mutual coupling between the antennas, for example in an antenna array.

It is an object of the present invention to provide an antenna or an antenna array system with an improved input impedance and port matching.

It is another object of the present invention to provide an antenna array with an optimal isolation between the antenna elements in an array.

It is further another object of the present invention to provide an antenna array with an increased antenna bandwidth.

According to a first aspect of some embodiments of the present invention, there is provided an antenna comprising: a plurality of dielectric layers, and a plurality of conducting layers, wherein at least one of said dielectric layers comprises one or more regions with differing dielectric properties.

In an embodiment the regions differ in the dielectric constant of a material embedded in said regions.

In an embodiment the antenna the regions are lateral regions in said dielectric layers.

In an embodiment the regions differ in the absorption coefficient of the material.

In an embodiment the antenna is produced using printed circuit board manufacturing techniques.

In an embodiment said material is embedded within said plurality of layers.

According to a second aspect of some embodiments of the present invention, there is provided an antenna array having a plurality of dielectric and conducting layers, said antenna comprising: a radiating component etched in said array top first layer; a reflector embedded in a second layer below said top layer; a feeding network located in a third layer below said reflector; a ground plane bottom layer configured to shield said feeding network in said bottom layer, wherein one of said layers is a non-uniform dielectric layer, said non-uniform dielectric layer comprises a material having a substantially different electrical properties compared to said array dielectric and conducting layers.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks, according to embodiments of the invention, could be implemented as a chip or a circuit.

### BRIEF DESCRIPTION OF THE DRAWINGS

The subject matter disclosed may best be understood by reference to the following detailed description when read with the accompanying drawings in which:

FIG. 1 is schematic cross section view of a multi-layer antenna, according to an embodiment of the prior art;

FIG. 2 is a cross section view of a multi-layer antenna comprising a non-uniform dielectric layer, according to one embodiment of the invention;

FIG. 3A is a cross section side view of an antenna array including a plurality of ‘cross’ shaped antenna, according to one embodiment of the invention;

FIG. 3B is a cross section side view of an absorbing material added across or between the cross shaped antenna array, according to one embodiment of the invention;

FIG. 3C is a view showing the antenna array associated with the absorbing material;

FIGS. 3D-3E are cross section side view of an antenna embedded in a multi-layer substrate including the absorbing material, according to one embodiment of the invention;

FIG. 3F-3H illustrate the antenna array parameters in wavelength;

FIG. 3I illustrates another three-dimension upper side cross section view of an antenna of the present invention;

FIG. 4A is a graph showing a comparison of an electric field 100 mm in front of an antenna of the present invention vs. a uniform substrate antenna of the prior art;

FIG. 4B is a graph showing a frequency response comparison in an electric field 100 mm in front of an antenna of the present invention vs. a uniform substrate antenna of the prior art;

FIGS. 4C and 4D are graphs showing a leakage between two adjacent antenna elements; and

FIGS. 4E and 4F are graphs further illustrating the port fmatching of the present invention composite antenna vs. uniform substrate of the prior art in the frequency domain (FIG. 4E) and time domain (FIG. 4F).

### DETAILED DESCRIPTION

The present invention relates to printed antennas for radiating and receiving electromagnetic waves and, more particularly to a low profile, printed antenna comprising non-uniform dielectric layers.

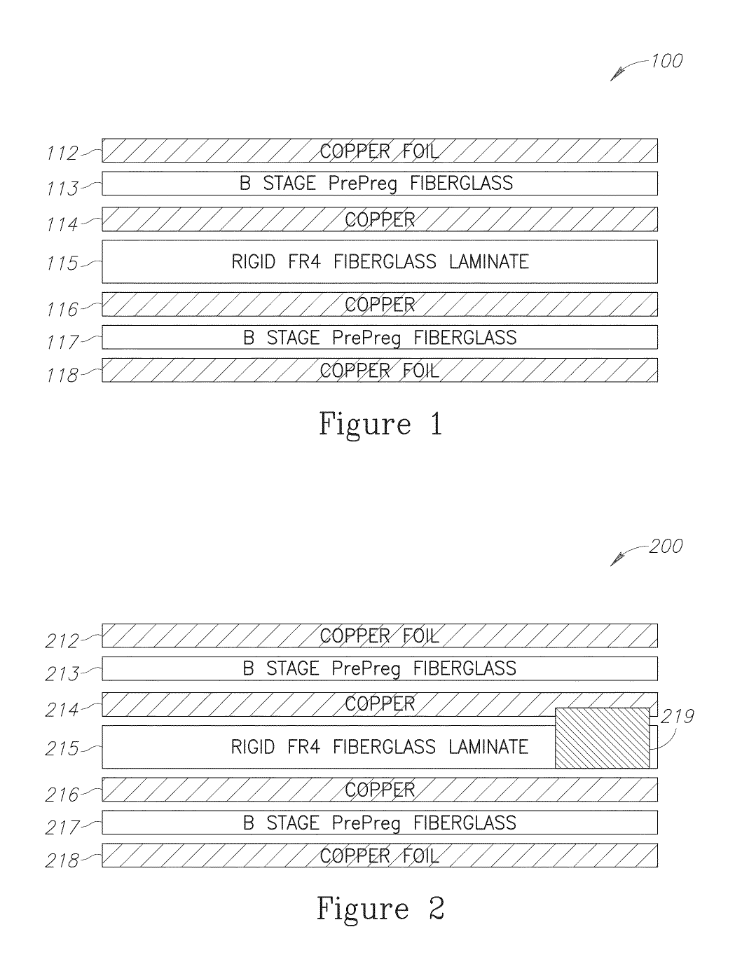

As illustrated in FIG. 1, an antenna such as PCB based antennas design and manufacturing methods used by prior art include a plurality of uniform dielectric layers included in the PCB multi-layer antenna. For example a low loss dielectric materials such as glass-epoxy or Teflon is used to entirely and or laterally fill the space between each pair of conducting layers.

The present invention provides a printed antenna, such as a multi-layer antenna comprising one or more non-uniform dielectric layers. More specifically the present invention provides a printed antenna comprising a plurality of dielectric layers, and a plurality of conducting layers, wherein at least one of the antenna's dielectric layer contains regions, such as lateral regions or sections with differing dielectric properties. According to one embodiment of the invention an absorbing material, such as an ECCOSORB® by Emerson & Cuming, is embedded within the dielectric layers, resulting in a non-uniform dielectric layer.

Typically, a power reflection coefficient of −10 db or lower is considered to be adequate in many applications having antennas or antenna arrays. The present invention provides an easy and simple mechanism to allow a broadband input matching, which according to prior art solutions is difficult and cumbersome to implement.

Reference is now made to FIG. 2 illustrating a cross section view of a multi layered PCB 200 comprising a non-uniform dielectric layer. According to one embodiment of the invention, the PCB 200 includes four conducting layers 212, 214, 216, 218 and three dielectric layers 213, 215 and 217. An antenna design embedded in the multi-layer PCB 200 may include for example the following components: a) a radiating component etched in the top conducting copper layer (212) b) a reflector (e.g. ground plane) embedded in the conducting layer below it (214) c) a feeding network in the layer below the reflector (216) and d) an additional ground plane to shield the feeding network in the bottom conducting layer (218).

According to one embodiment of the invention at least one of the layers such as the dielectric layer 215 may be a non-uniform dielectric layer including an element 219 comprising a material having a substantially different electrical properties compared to the layers (i.e. 215) hosting original material (i.e. FR4 Fiberglass as shown in FIG. 2).

According to another embodiment of the invention there is provided a low profile antenna array embedded in a substrate such as a multi-layer PCB including one or more non-uniform layers such as a non-uniform dielectric layer surrounding the antenna array.

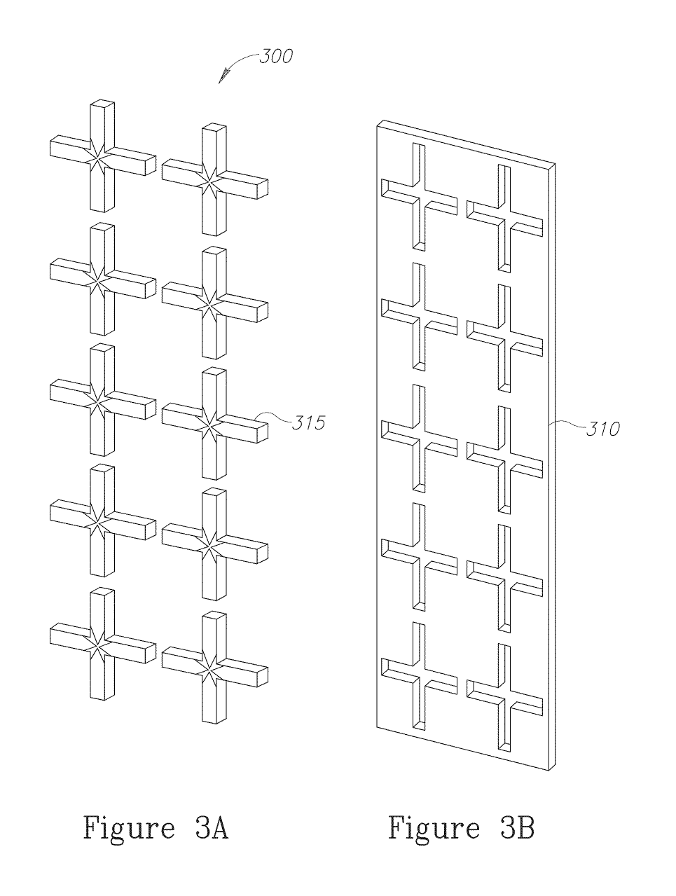

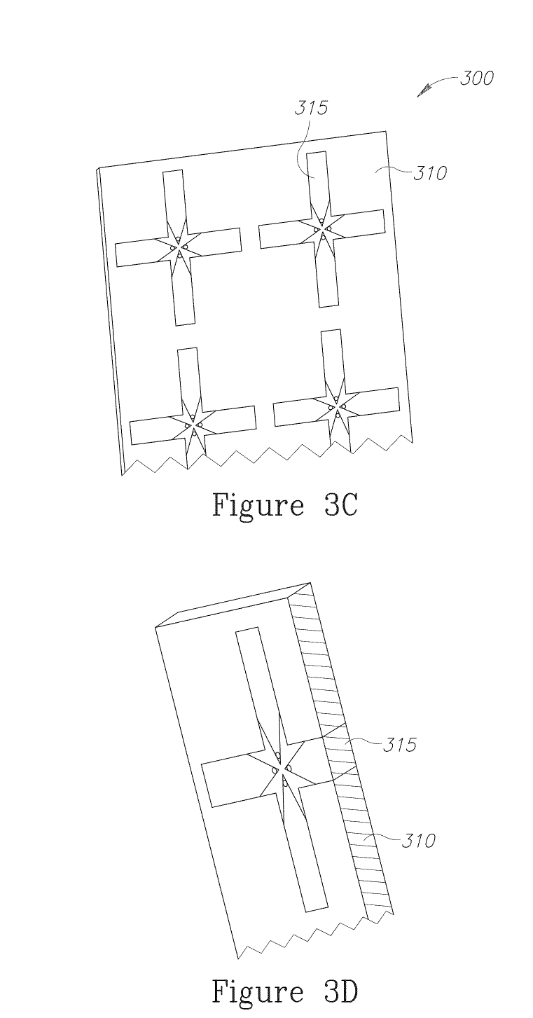

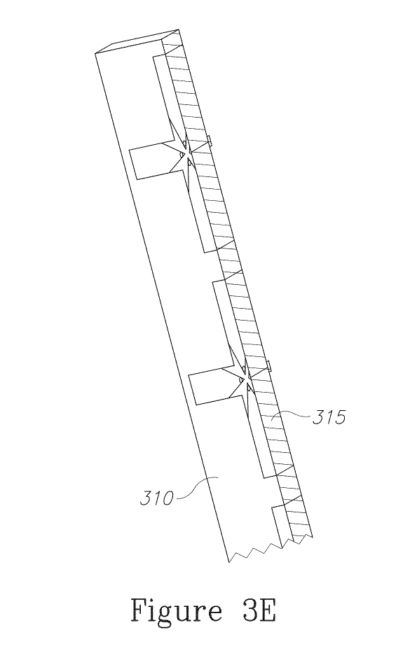

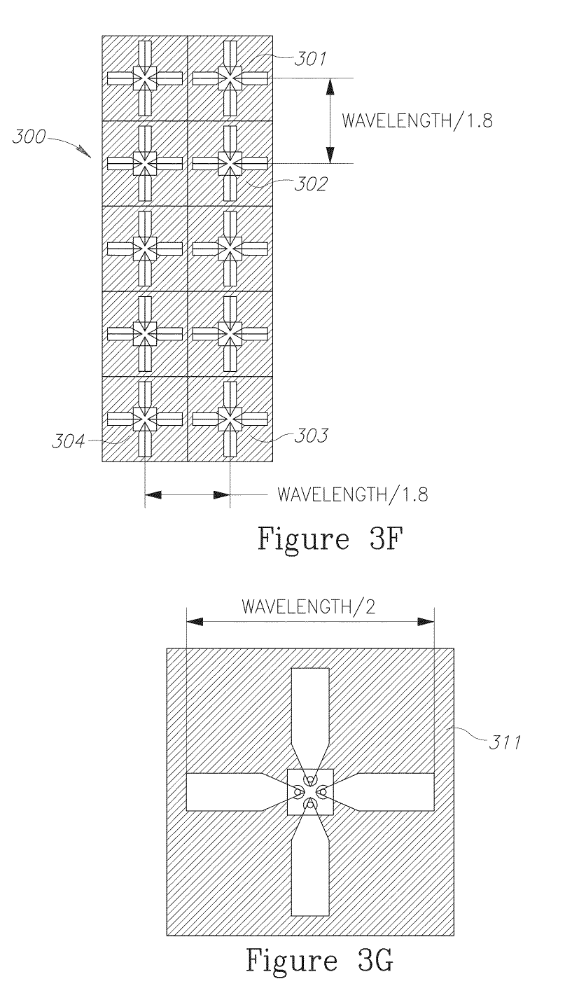

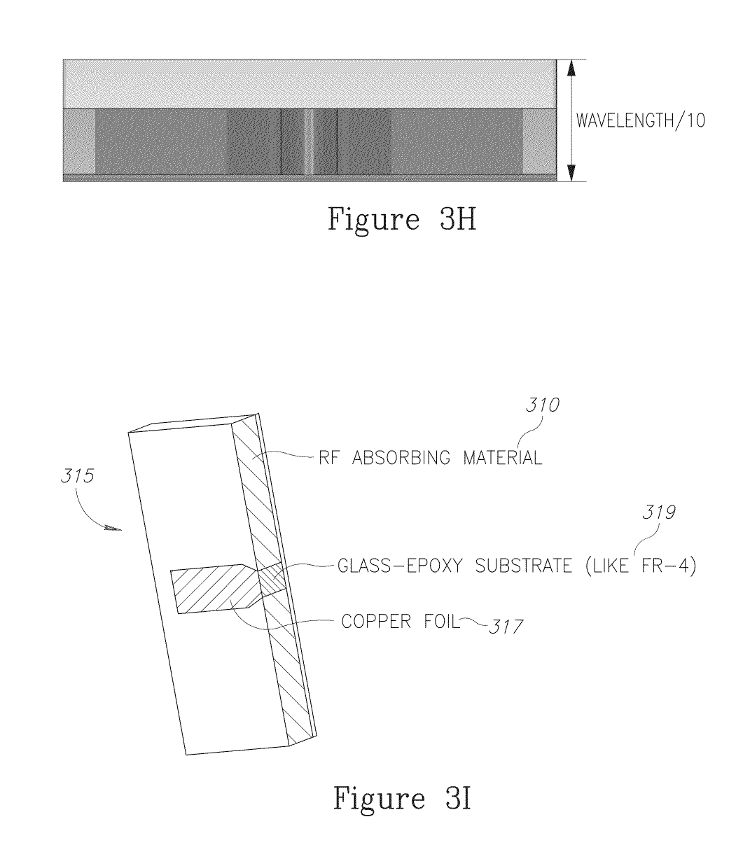

FIG. 3A illustrates an antenna array 300 including a plurality of ‘cross’ shaped antenna 315 embedded for example in a PCB. As shown in FIG. 3B an absorbing material 310 is added across or between the ‘cross’ shaped antenna array surrounding the antenna array and absorbing and isolating between the antenna array elements as further illustrated in FIG. 3C.

FIG. 3D-3E are cross section side view of an antenna embedded in a multi-layer substrate including the absorbing material 310 covering/surrounding the antenna layers 315 in the Y-X axis.

FIG. 3F-3H illustrate the antenna array 300 parameters in wavelength according to some embodiments of the invention. As shown in FIG. 3F, the wavelength in the Y axis between two adjutant antennas 301 and 302 and in the X axis between antennas 303 and 304 may be wavelength/1.8. The wavelength in the X axis of a single antenna 311 as shown in FIG. 3G may be wavelength/2 and the wavelength in the Z axis of the antenna 311 as shown in FIG. 3G may be wavelength/10.

FIG. 3I illustrates another three dimension upper side cross section view of antenna 315. In the external Y-X cross section layer the antenna 315 comprises a copper foil layer 317 and in the internal layer below (i.e. Z-Y cross section) a Glass-Epoxy substrate layer 319, and the RF absorbing material 310 surrounds the Copper foil 317 elements and the Glass Epoxy substrate in the Y-X axis cross section and the Y-X cross section.

The introduction of an absorbing material as part of a standard laminate as illustrated in FIGS. 3A-3I has some important merits and advantages for antenna performance in certain applications including for example:
improved antenna input impedance and port matching e.g. -power reflection coefficient of around −10 db,(compared to −3 db as employed by prior art solutions).
increased isolation between the antenna or antenna array elements, e.g. an improvement of 5 to 10 db in isolation across a wide frequency range.
attenuated antenna surface waves;
lowered antenna cross section thus, providing a stealthier antenna structure;
increased antenna bandwidth;
antenna's radiation pattern is constant along a wider frequency band; and
time domain shape of the signals propagating through the antenna structure are less distorted.

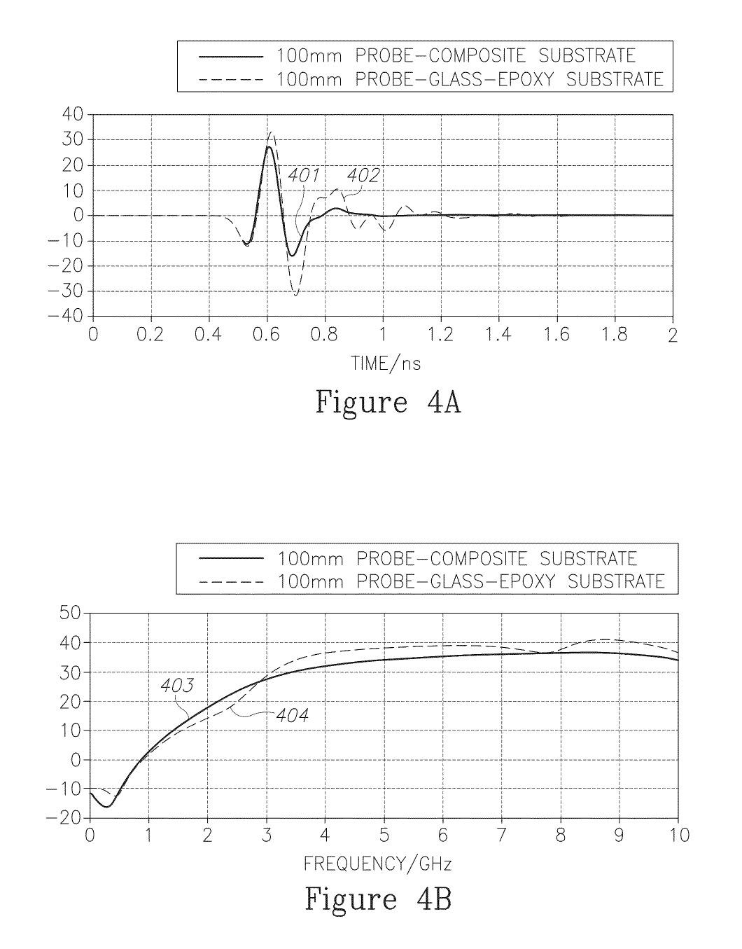

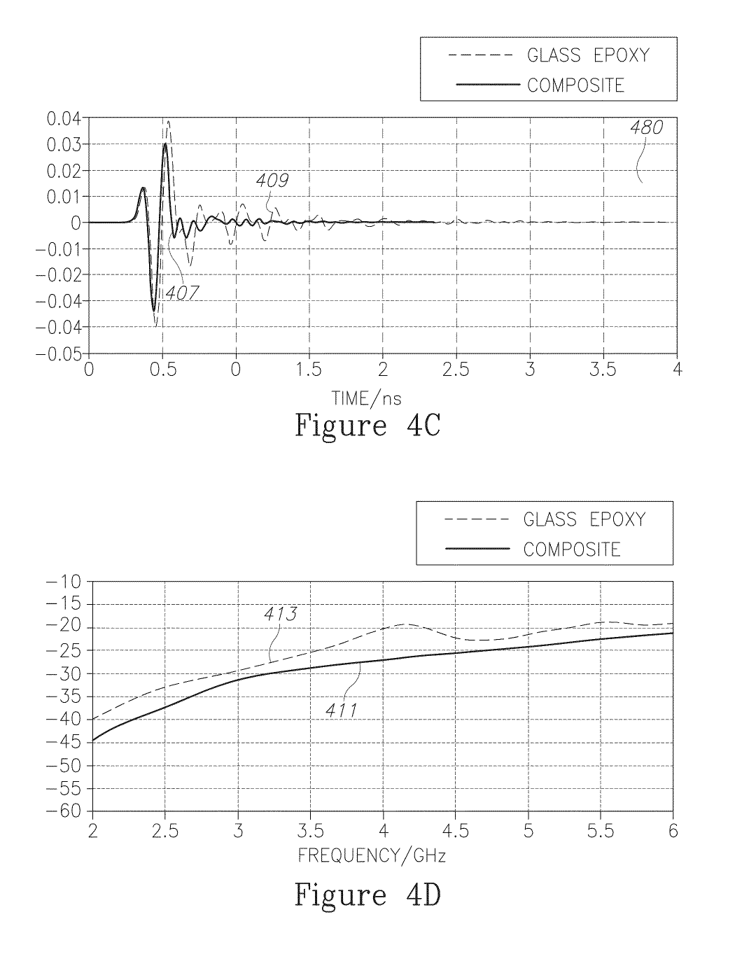

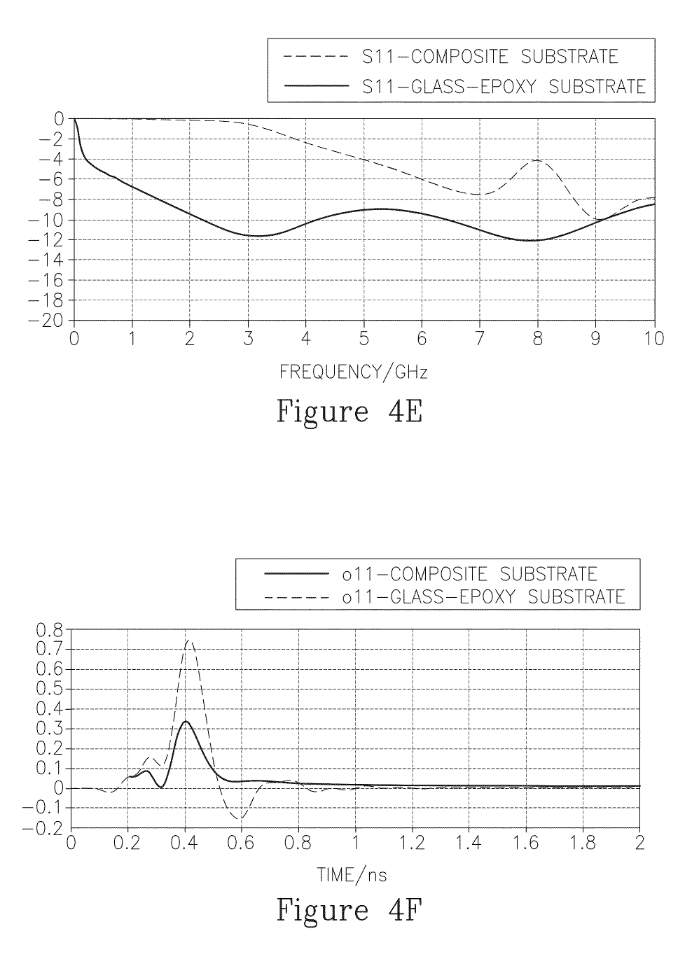

These advantages are further illustrated in FIGS. 4A-4F.

FIG. 4A shows a comparison of Electric-Field 100 mm in front of an antenna 315 of the present invention Vs. a Uniform Substrate antenna of the prior art. A black curve 401 represents the Composite antenna (e.g. antenna 315) of the present invention and the dotted curve 402 represent the Uniform Substrate antenna of the prior art. Though both curves start around 0.45 ns curve 401 is restrained and constant in time while curve 402 continues to be distorted in time. FIG. 4B shows a frequency response comparison in an Electric-Field 100 mm in front of an antenna 315 of the present invention Vs. a Uniform Substrate antenna of the prior art. As shown, black curve 403 of the present invention antenna provides a more flat and low frequency response compared to the dotted curve 404 representing the frequency response of the prior art antenna.

FIGS. 4C and 4D shows a leakage between two adjacent antenna elements, such as in antenna array of the present invention compared to the prior art antenna array.

FIG. 4C presents black curve 407 representing the leakage of an antenna of the present invention and dotted curve 409 of the prior art in the time domain. As shown, the time response of the present invention antenna (e.g. antenna 315) leakage settles faster, thus providing short pulses which don't distort adjacent antenna signals in the antenna array.

FIG. 4D shows two curves, e.g. black curve 411 of the present invention antenna and dotted curve 413 of the prior art in frequency domain. As shown, the present invention antenna's leakage is about 5 db lower than the prior art antenna, demonstrating clearly that the antenna according to the present invention is more isolated with an increased isolation between the antenna or antenna array elements, e.g. an improvement of 5 to 10 db in isolation across a wide frequency range.

FIGS. 4E and 4F further illustrate the port matching (S11) of the present invention composite antenna vs. Uniform Substrate of the prior art in the frequency domain (FIG. 4E) and time domain (FIG. 4F). As clearly shown the present invention antaean provides a better antenna matching compared to the prior art antenna,

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An antenna comprising:
a plurality of dielectric layers, and a plurality of conducting layers, wherein at least one of said dielectric layers comprises one or more regions with differing dielectric properties.

2. The antenna according to claim 1, wherein the regions differ in the dielectric constant of a material embedded in said regions.

3. The antenna according to claim 1, wherein the regions are two regions in said dielectric layers.

4. The antenna according to claim 2, wherein the regions differ in the absorption coefficient of the material.

5. The antenna of claim 1, wherein the antenna is produced using printed circuit board manufacturing techniques.

6. The antenna according to claim 2 wherein said material is embedded within said plurality of layers.

7. The antenna according to claim 4 wherein said material is an absorbing material selected from the group consisting of: ECCOSORB® by Emerson & Cuming.

8. An antenna array comprising a plurality of antennas arranged on a plurality of dielectric and conducting layers, said antenna array comprising:
a radiating component etched in said array top first layer;
a reflector embedded in a second layer below said top layer;
a feeding network located in a third layer below said reflector;
a ground plane bottom layer configured to shield said feeding network in said bottom layer, wherein at least one of said layers is a non-uniform dielectric layer, said non-uniform dielectric layer comprises a material having a substantially different electrical properties compared to said array dielectric and conducting layers.

9. The antenna array according to claim 8 wherein said plurality of dielectric and conducting layers are part of a PCB (Printed Circuit Board).

10. The antenna array according to claim 9 wherein said antennas are cross shaped and embedded in said PCB.

11. The antenna array according to claim 9 wherein said material surrounds the antenna array to isolate the antenna array.
